(19) United States
(12) Patent Application Publication
(10) Pub. No.: US 2026/0154849 A1
(43) Pub. Date: Jun. 4, 2026

(54) HISTOGRAM BASED INTELLIGENT FRAME DROPPING FOR SMOOTH MOTION

(71) Applicant: QUALCOMM Incorporated, San Diego, CA (US)

(72) Inventors: Hitesh Venkata RACHAKONDA, Hyderabad (IN); Ankita CHAUDHA, Hyderabad (IN); Sridhar Rao NUNE, Hyderabad (IN)

(21) Appl. No.: 18/966,002

(22) Filed: Dec. 2, 2024

(51) Int. Cl. G06T 7/90; G06T 7/11; G06V 10/56; G06V 10/74

(52) U.S. Cl. CPC G06T 7/90; G06T 7/11; G06V 10/56; G06V 10/761; G06T 2207/10024

(57) ABSTRACT

This disclosure provides systems, devices, apparatus, and methods, including computer programs encoded on storage media, for histogram-based frame dropping for smooth motion. A display processor may be configured to generate a data structure indicative of a spread of color tones between a set of image frames associated with a first frame rate of a source application. The display processor may also be configured to output a rate-matched set of image frames at a second frame rate associated with a display panel by dropping a first subset of image frames associated with the set of image frames based on the spread of color tones. The display processor may be configured to output the rate-matched set of image frames at the second frame rate by duplicating a second subset of image frames of the set of image frames based on the spread of color tones.

### TECHNICAL FIELD

The present disclosure relates generally to communication systems, and more particularly, to techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for smooth motion, associated with frame rate matching between applications and display panels, may be associated with patterned algorithms or mathematical models for dropping or adding image frames based on the total number of image frames. There is a need for improved techniques for smooth motion to account for pixel data, such as color tones, of the image frames.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: generate a data structure indicative of a spread of color tones between a set of image frames associated with a first frame rate of a source application, duplicate a second subset of image frames of the set of image frames based on the second frame rate being greater than the first frame rate, and output a rate-matched set of image frames at a second frame rate associated with a display panel by dropping a first subset of image frames associated with the set of image frames based on the spread of color tones.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating frame rate matching between an application and display panel.

FIG. 5 is a diagram illustrating an example histogram for frame dropping for smooth motion in accordance with one or more techniques of this disclosure.

FIG. 6 is a diagram illustrating example histogram-based frame dropping for smooth motion in accordance with one or more techniques of this disclosure.

FIG. 7 is a diagram illustrating example histogram-based frame dropping for smooth motion in accordance with one or more techniques of this disclosure.

FIG. 8 is a diagram illustrating example tile-based histograms for frame dropping for smooth motion in accordance with one or more techniques of this disclosure.

FIG. 9 is a call flow diagram illustrating example communications between a display processor and a display panel in accordance with one or more techniques of this disclosure.

FIG. 10 is a flowchart of a method of wireless communication.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “color tone of an image” may refer to Red (R), Green (G), and Blue (B) color components of the image. As used herein, the terms “a spread of color tones” or “a color tone spread” may refer to a change in color tone of pixels or content for an image frame. As used herein, the term “color tone delta” or the symbol “(Δ)” may refer to a difference or comparison in the color tones (e.g., Red (R), Green (G), and Blue (B) color components) between an image in a frame and an image adjacent frame. As used herein, the term “rate matching” may refer to handling of source image frames for adjustments to achieve a different, target frame rate. As used herein, the term “data structure” may refer to an organized representation of data such as a list, table, histogram, and/or the like. As used herein, the terms “adding,” “repeating,” and “duplicating” in the context of image frames for frame rate matching may refer to any type of image frame copying, described herein, and may be used interchangeably.

A display processing unit (DPU) or other display processor (e.g., the display processor 127), a wireless communication device, and/or the like, may adapt a source stream of image frames (e.g., from a game or other type of application/workload) at a source frame rate to a target frame rate of a display panel. Correction and/or mitigation of mismatches in frame rates (e.g., frames per second or FPS) between sources of image frames and display panels may be utilized to provide and maintain smooth motion of video displayed for a user. In some examples, a DPU or the like may utilize a combination of frame pacing to delay image frames for frame synchronization with frame rate control (FRC) and/or display refresh rate control (DRC) to match the source frame rate with the target frame rate. In some cases, image frames may be dropped to reduce the frame rate of the source relative to the display panel, while in other cases, image frames may be duplicated to increase the frame rate of the source relative to the display panel, while in other cases, both duplication and dropping of different frames may be used in order to match the frame rates. However, examples of smooth motion techniques are associated with patterned algorithms or mathematical models for dropping or adding image frames based on the total number of image frames. For instance, regardless of respective contents/characteristics, every other image frame may be dropped to halve the source frame rate for a reduction, or every third image frame may be duplicated to increase the source frame rate. Yet rigidly applied patterned algorithms or mathematical models associated with frame rate matching between applications and display panels do not account for characteristics of image frames, such as pixel data, color tones, etc. Some image frames may have little change in color tones, and other image frames may have huge differences in color tones, but these characteristics are not taken into consideration in patterned algorithms or mathematical models.

To achieve smooth motion in gaming, DPUs may utilize two strategies, FRC and DRC, to synchronize the game/application FPS with the panel refresh rate. This results in frames being repeated, dropped, or both. The logic for repeating or dropping frames is not based on pixel data for smooth motion techniques. Aspects herein for histogram-based intelligent frame dropping for smooth motion utilize local histograms for each frame to analyze color tones and compute the color tone delta between frames. The frames with the least color tone changes will be the ones dropped and/or added (e.g., duplicated/repeated). Accordingly, rather than relying on a patterned algorithm or a mathematical model to compute the frames to be dropped or repeated, aspects provide for utilizing local histograms to be employed for each frame to analyze pixel data of the frames, such as the color tones. Aspects provide for frame dropping/duplicating mechanisms that are more intelligent than dropping frames alternatively. Thus, frame transitions are smoother, including while using frame pacing for delay of image frames in frame synchronization, with the histogram-based frame dropping aspects herein. The techniques provided according to aspects herein are further extensible to other use cases, such as but not limited to, camera implementations where frame pacing for delay of image frames in frame synchronization may be deployed.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

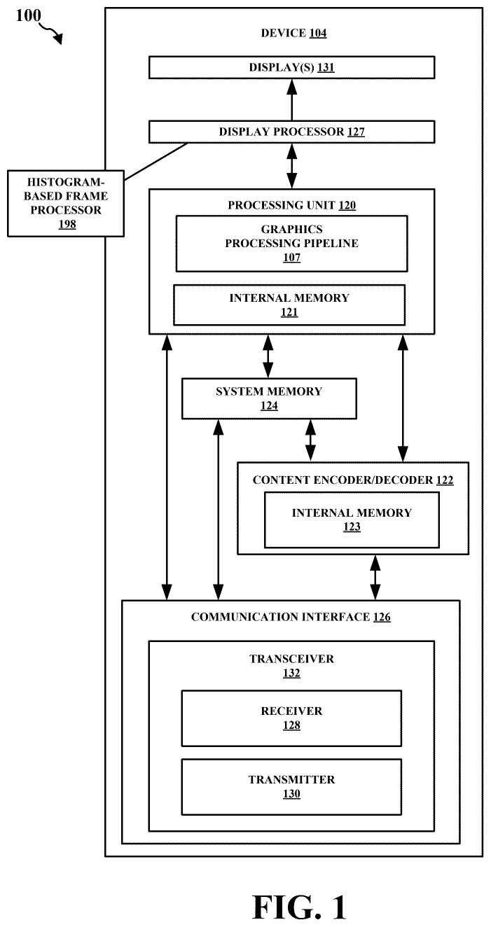

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a histogram-based frame processor 198 configured to generate a data structure indicative of a spread of color tones between a set of image frames associated with a first frame rate of a source application, and output a rate-matched set of image frames at a second frame rate associated with a display panel by dropping a first subset of image frames associated with the set of image frames based on the spread of color tones. The histogram-based frame processor 198 may also be configured to duplicate a second subset of image frames of the set of image frames based on the second frame rate being greater than the first frame rate. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

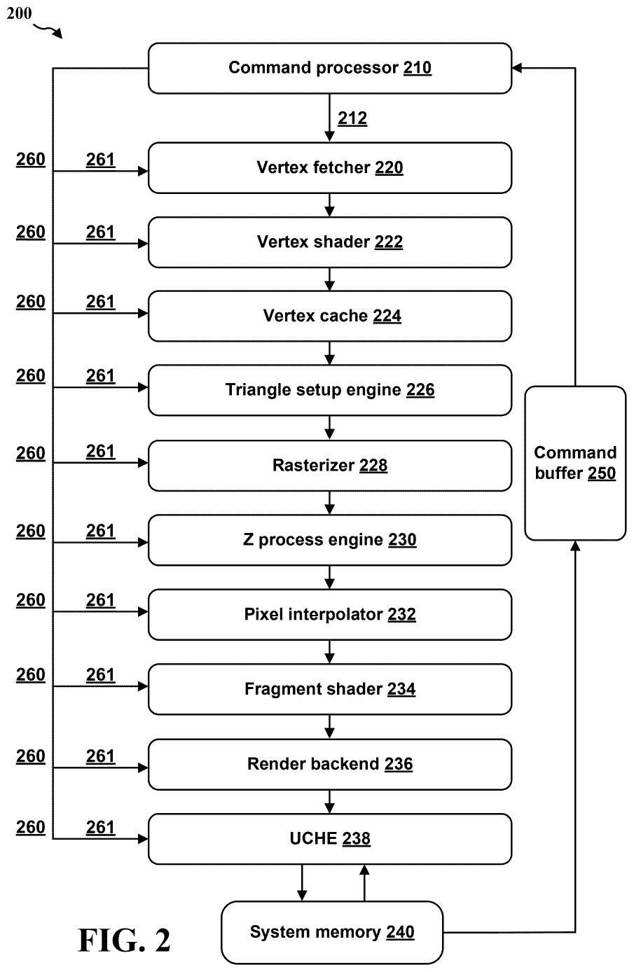

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

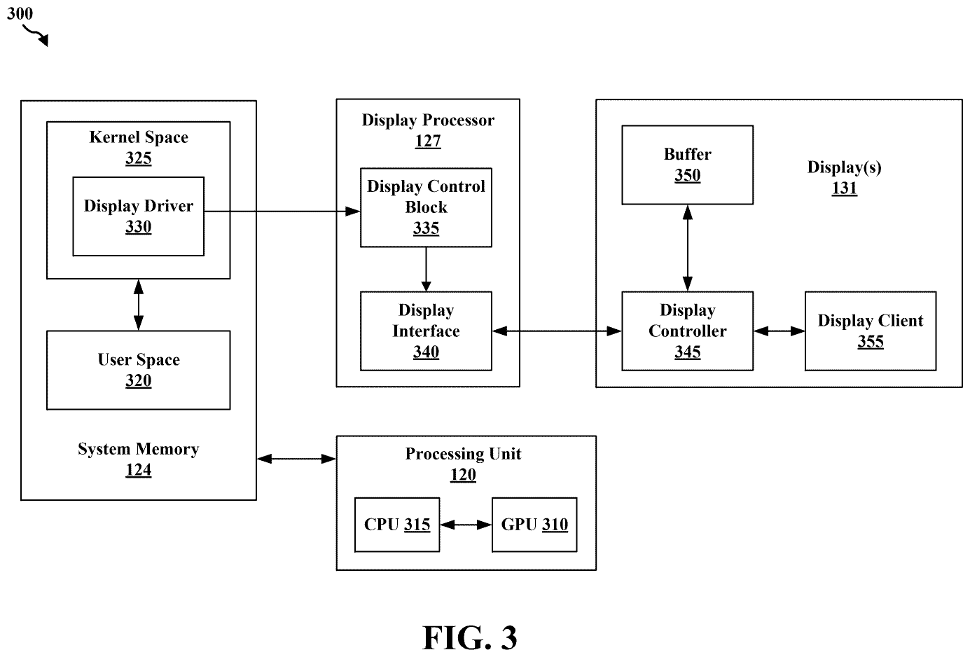

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

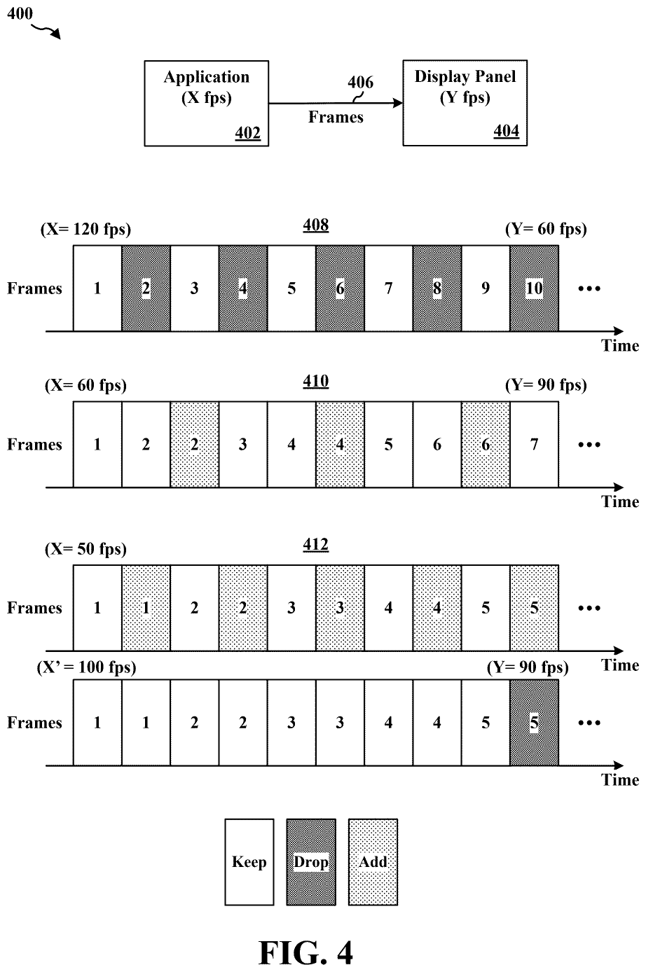

FIG. 4 is a diagram 400 illustrating frame rate matching between an application and display panel. Diagram 400 shows an application 402, e.g., a frame image source having a frame rate of X FPS for frames 406, and a display panel 404, e.g., a frame image target capable of handling a frame rate of Y FPS. In the examples shown for diagram 400, X and Y are different values, and in cases with the FRC strategy being used, frames may be repeated or dropped for rate matching.

In a scenario 408, the application 402 may provide image data at a frame rate of 120 FPS (X), and the display panel 404 may be configured to handle a frame rate of 60 FPS (Y). In the scenario 408, a DPU or the like may be configured to drop half of the frames 406 in order to rate match 120 FPS (X) with the frame rate of 60 FPS (Y) at the display panel 404. That is, 60 frames of every 120 FPS will be dropped to achieve rate matching at 60 FPS, and every other frame of the frames 406 may be dropped according to a patterned algorithm or a mathematical model based on the total number of the frames 406 and uniform pattern of a number of the frames 406 are to be dropped (e.g., without consideration for content or characteristics of pixels in a given frame). As shown, frames 2, 4, 6, 8, . . . , 30 will be dropped based on the pattern.

In a scenario 410, the application 402 may provide image data at a frame rate of 60 FPS (X), and the display panel 404 may be configured to handle a frame rate of 90 FPS (Y). In the scenario 410, a DPU or the like may be configured to add (e.g., duplicate/repeat) every alternate frame of the frames 406 in order to rate match 60 FPS (X) with the frame rate of 90 FPS (Y) at the display panel 404. That is, 30 frames of every 60 FPS will be added (e.g., duplicated/repeated) to achieve rate matching at 90 FPS according to a patterned algorithm or a mathematical model based on the total number of the frames 406 and uniform pattern of a number of the frames 406 are to be duplicated/repeated (e.g., without consideration for content or characteristics of pixels in a given frame). As shown, frames 2, 4, 6, 8, . . . , 30 will be duplicated/repeated based on the pattern.

In a scenario 412, the application 402 may provide image data at a frame rate of 50 FPS (X), and the display panel 404 may be configured to handle a frame rate of 90 FPS (Y). In the scenario 412, according to the relationship between X and Y, a DPU or the like may be configured to add (e.g., duplicate/repeat) and drop image frames to achieve rate matching. For example, a frame rate X′ of 100 FPS may be generated by duplicating/repeating every frame of the frames 406 in order to obtain a frame rate above 90 FPS (Y). Thus, 10 frames will then be dropped (e.g., 100−90=10). For example, every tenth image frame present after the duplication/repetition of the frames 406 may be dropped to achieve 90 FPS (Y) for the display panel 404 (e.g., drop a second instance of frame 5 at the tenth position, a second instance of frame 10 at the twentieth position, second instance of frame 15 at the thirtieth position, etc., without consideration for content or characteristics of pixels in a given frame).

The example scenarios above may be representative of various cases that can arise at runtime/in real time for mismatches between frame rates of applications and supported modes of display panels. Yet, the example techniques shown in diagram 400 to drop/repeat frames by performing an equal split count for repetition (e.g., to duplicate/repeat half the frames, where every other frame is duplicated/repeated), or for dropping (e.g., to drop 10 out 100 frames, where every 10^{th} frame is dropped), etc., are simply mathematical/logic applications via models or algorithms that do not consider any information regarding the frame pixel data. Some image frames may have little change in color tones, and other image frames may have huge differences in color tones, but these characteristics are not taken into consideration in patterned algorithms or mathematical models. In aspects, local histograms, such as the histogram 502, may be employed for each image frame of the set of image frames 504 to analyze the color tones and the color tone spread 506.

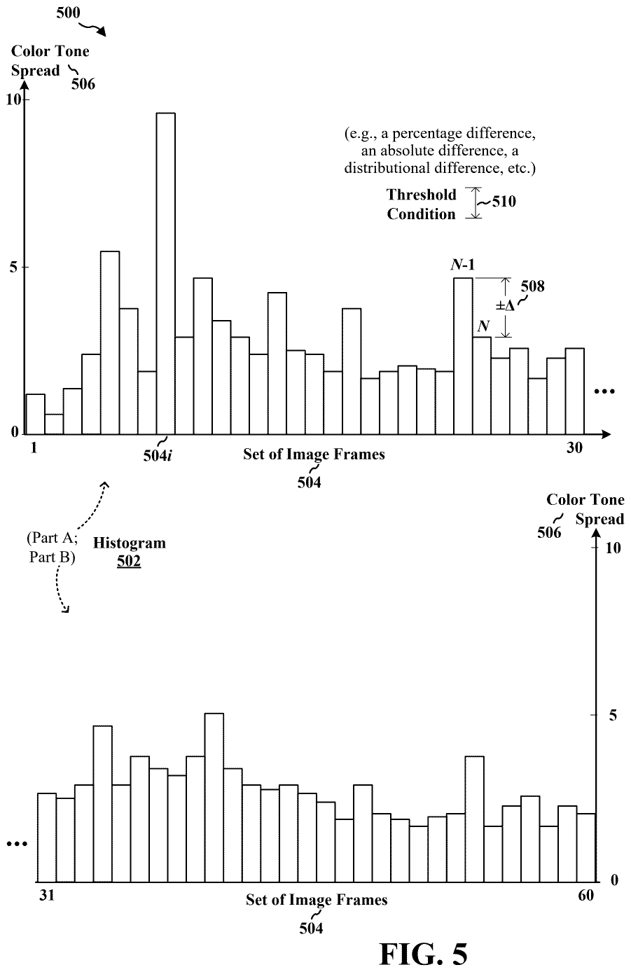

FIG. 5 is a diagram 500 illustrating an example histogram for frame dropping for smooth motion in accordance with one or more techniques of this disclosure. Diagram 500 shows a histogram 502, e.g., a histogram local to a display processor/DPU or the like, for sixty (60) image frames, e.g., a set of image frames 504, at a frame rate of 60 FPS, by way of example, against a color tone spread 506. In aspects, the histogram 502 may be generated by a display processor/DPU or the like, e.g., the display processor 127/the histogram-based frame processor 198 in FIG. 1.

In aspects, the color tone spread 506 may be representative of a change in color tone of pixels or content for an image frame of the set of image frames 504. That is, an image frame with higher change in color tone will have a correspondingly higher value for the color tone spread 506. A color tone delta (Δ) 508 may represent the difference in color tones between a given image frame of the set of image frames 504 and an adjacent image frame, and may be based on information of the histogram 502. For example, a given image frame N is shown as having the color tone delta (Δ) 508 in association with a preceding, adjacent image frame N−1. In aspects, the color tone delta (Δ) 508 may be positive or negative with respect adjacent image frames, or may be referenced as an absolute value of the color tone difference.

In aspects, a threshold condition 510 (also a difference threshold condition 510) may be associated with a threshold by which adjacent image frames of the set of image frames 504 are determined to be alike enough in color tone, or divergent enough in color tone, to keep/maintain, to drop, and/or to add/duplicate/repeat a given image frame. As an example, the color tone delta (Δ) 508 may be determined between a given image frame N and a preceding, adjacent image frame N−1. The color tone delta (Δ) 508 may then be compared against the threshold condition 510. If the threshold condition 510 is met by the color tone delta (Δ) 508, image frame N may be a candidate for dropping and/or for to adding/duplicating/repeating based on the likeness for the color tone spread 506 with the previous image frame N−1 (e.g., which improves smoothness of motion for frame rate matching). If the threshold condition 510 is not met by the color tone delta (Δ) 508, image frame N may not be a candidate for dropping and/or for to adding/duplicating/repeating based on the difference for the color tone spread 506 with the previous image frame N−1 (e.g., which may degrade smoothness of motion for frame rate matching). In aspects, the threshold condition 510 may be percentage difference of color tone spreads, an absolute difference of the values for the color tone spread 506, a distributional difference of color tone spreads (e.g., in the context of a mean and one or more standard deviations thereof), and/or the like.

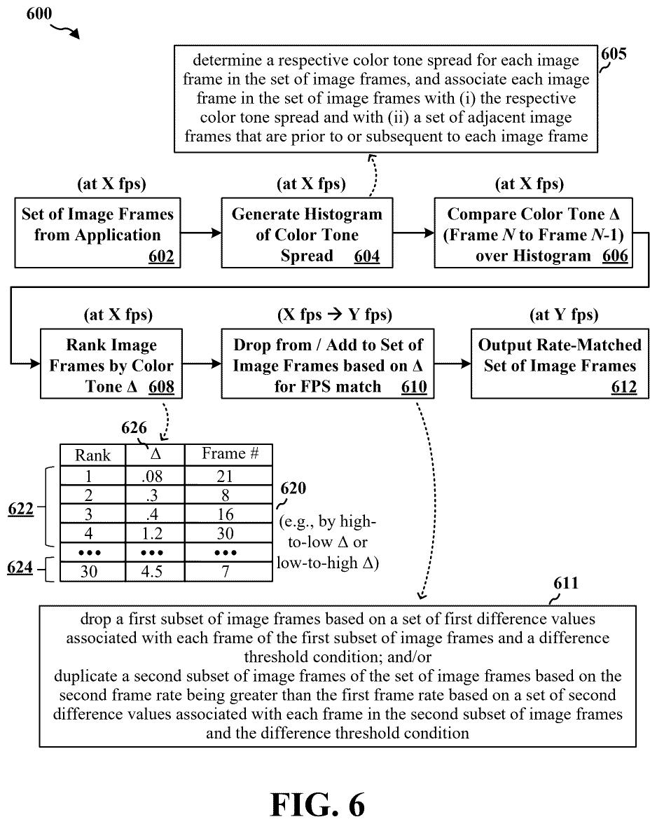

FIG. 6 is a diagram 600 illustrating example histogram-based frame dropping for smooth motion in accordance with one or more techniques of this disclosure. Diagram 600 may be an aspect of diagram 500 in FIG. 5. In aspects, operations of diagram 600 may be performed by a display processor/DPU or the like, e.g., the display processor 127/the histogram-based frame processor 198 in FIG. 1. As noted above with respect to the histogram 502 in FIG. 5, a color tone delta (Δ) 626 may be determined/computed between each image frame of a set of image frames based on histogram information.

In aspects, a set of image frames 602 from an application (e.g., a source application) may be received at a frame rate (e.g., X FPS) associated with the application for output at a different frame rate (e.g., Y FPS, such as for a display panel). At 604, a display processor may be configured to generate a histogram of color tone spread for the set of image frames 602 (e.g., the histogram 502 in FIG. 5). Such a histogram may be a data structure indicative of a spread of color tones between a set of image frames associated with a first frame rate of a source application. In aspects, to generate the histogram, the display processor may be configured (at 605) to determine a respective color tone spread for each image frame in the set of image frames, and associate each image frame in the set of image frames with (i) the respective color tone spread and with (ii) a set of adjacent image frames that are prior to or subsequent to each image frame.

In aspects, the display processor may be configured to compare (at 606) a color tone delta (Δ) over the histogram for each image frame with respect to an adjacent image frame. In aspects, the color tone deltas (Δ) 626 over the histogram may be determined by the display processor as a set of first difference values indicative of first differences between first color tone spreads of the spread of color tones associated with first image frames and second color tone spreads of the spread of color tones associated with second image frames that are adjacent to the first image frames (e.g., sequentially right before or after). In aspects, the display processor may be configured to rank (at 608) the image frames represented in the histogram based on their respective color tone delta (Δ) 626. For instance, a ranking data structure 620 may represent the ranked image frames (e.g., low-to-high or high-to-low, without limitation). A subset 622 of the ranked image frames may be determined as having a number of lowest values for the color tone delta (Δ) 626 such that the corresponding number of frames may be utilized for dropping and/or for to adding//plicating/repeating in order to rate match the frame rate X FPS with the frame rate Y FPS. In aspects, the subset 622 may comprise image frames based on a number of image frames for a rate matching operation, a meeting/failing of a threshold condition for the color tone delta (Δ) 626, as described herein, and/or the like. A subset 624 of the ranked image frames may be determined as having a number of highest values for the color tone delta (Δ) 626 such that the corresponding number of frames may be utilized for dropping and/or for to adding duplicating/repeating in order to rate match the frame rate X FPS with the frame rate Y FPS. In aspects, the subset 624 may comprise image frames based on a number of image frames for a rate matching operation, a meeting/failing of a threshold condition for the color tone delta (Δ) 626, as described herein, and/or the like.

In aspects, the display processor may be configured to drop image frames from/add image frames to (at 610) the set of image frames. In aspects, the dropping/adding (at 610) may be based on the histogram, the color tone spread, the color tone delta(s) (Δ) 626, as described herein, and/or the like, for achieving a frame rate match between the frame rate X FPS and the frame rate Y FPS. In aspects, the display processor may be configured to drop a first subset of image frames associated with the set of image frames based on the spread of color tones, a threshold condition, and/or the like. In aspects, the display processor may be configured to drop image frames (at 610/611) from the set of image frames based on a set of first difference values associated with each frame of the first subset of image frames and a difference threshold condition. In aspects, the display processor may be configured to duplicate/add a second subset of image frames of the set of image frames based on the second frame rate being greater than the first frame rate, and/or based on the spread of color tones, a threshold condition, and/or the like. In aspects, the display processor may be configured to add/duplicate image frames (at 610/611) to the set of image frames based on the second frame rate being greater than the first frame rate based on a set of second difference values associated with each frame in the second subset of image frames and the difference threshold condition.

Based on the operation(s) at 610, the display processor may be configured to output (at 612) an adjusted/a rate-matched set of image frames (e.g., for storage thereof, for provision to the display panel, etc.). That is, the display processor may be configured to output (at 612) a rate-matched set of image frames at a second frame rate associated with a display panel by dropping a first subset of image frames associated with the set of image frames based on the spread of color tones.

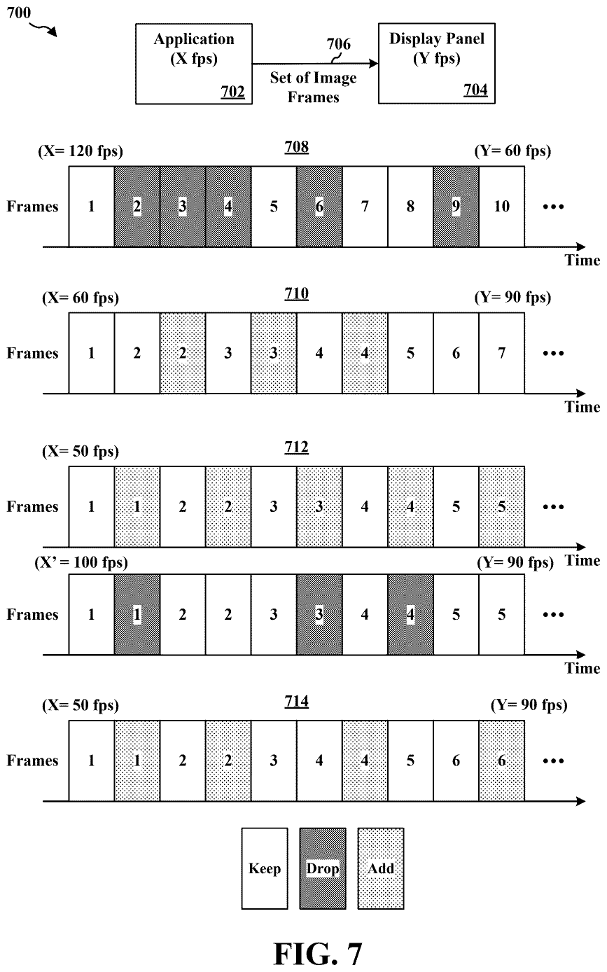

FIG. 7 is a diagram 700 illustrating example histogram-based frame dropping for smooth motion in accordance with one or more techniques of this disclosure. Diagram 700 shows an application 702, e.g., a frame image source having a frame rate of X FPS for a set of image frames 706, and a display panel 704, e.g., a frame image target capable of handling a frame rate of Y FPS. In the examples shown for diagram 700, X and Y are different values. Diagram 700 may be aspect of diagram 500 in FIG. 5 and/or diagram 600 in FIG. 6. In aspects, operations of diagram 700 may be performed by a display processor/DPU or the like, e.g., the display processor 127/the histogram-based frame processor 198 in FIG. 1.

In a scenario 708, the application 702 may provide image data at a frame rate of 120 FPS (X), and the display panel 704 may be configured to handle a frame rate of 60 FPS (Y). In the scenario 708, a display processor may be configured to drop half of the set of image frames 706 in order to rate match 120 FPS (X) with the frame rate of 60 FPS (Y) for the display panel 704. That is, 60 frames of every 120 FPS may be dropped to achieve rate matching at 60 FPS. However, unlike the patterned algorithm or a mathematical model described with respect to FIG. 4, image frame determinations for dropping in the scenario 708 are not made based on alternate frame dropping logic. Rather, the display processor may be configured to determine which image frames of the set of image frames 706 are to be dropped based on a spread of color tones, as described for aspects herein with reference to the diagram 500 in FIG. 5 and the diagram 600 in FIG. 6 (e.g., with consideration for content/characteristics of pixels in a given frame). As shown, frames 2, 3, 4, 6, 9, . . . , will be dropped based on the color tone spread and respective color tone delta (Δ) values for the image frames. It should also be noted that aspects for provide for consecutive frames to be dropped based on the color tone spread and respective color tone delta (Δ) values for the image frames, should the threshold condition be met and/or should the image frames be in subset of those with the lowest color tone delta (Δ), as noted above.

In a scenario 710, the application 702 may provide image data at a frame rate of 60 FPS (X), and the display panel 704 may be configured to handle a frame rate of 90 FPS (Y). In the scenario 710, a display processor may be configured to add (e.g., duplicate/repeat) ones of the set of image frames 706 in order to rate match 60 FPS (X) with the frame rate of 90 FPS (Y) at the display panel 704. That is, 30 frames of every 60 FPS will be added (e.g., duplicated/repeated) to achieve rate matching at 90 FPS. However, unlike the patterned algorithm or a mathematical model described with respect to FIG. 4, image frame determinations for dropping in the scenario 710 are not made based on alternate frame duplication logic. Rather, the display processor may be configured to determine which image frames of the set of image frames 706 are to be dropped based on a spread of color tones, as described for aspects herein with reference to the diagram 500 in FIG. 5 and the diagram 600 in FIG. 6 (e.g., with consideration for content/characteristics of pixels in a given frame). As shown, frames 2, 3, 4, 7, . . . , will be duplicated based on the color tone spread and respective color tone delta (Δ) values for the image frames (instead of frames 2, 4, 6, 8, . . . 30 based on an alternating pattern). It should also be noted that aspects for provide for consecutive frames to be duplicated/added based on the color tone spread and respective color tone delta (Δ) values for the image frames, should the threshold condition be met and/or should the image frames be in subset of those with the lowest color tone delta (Δ), as noted above.

In a scenario 712, the application 702 may provide image data at a frame rate of 50 FPS (X), and the display panel 704 may be configured to handle a frame rate of 90 FPS (Y). In the scenario 712, according to the relationship between X and Y, a display processor may be configured to add (e.g., duplicate/repeat) and to drop image frames to achieve the rate matching. For example, a frame rate X′ of 100 FPS may be generated by duplicating/repeating every frame of the set of image frames 706 in order to obtain a frame rate above 90 FPS (Y), or by duplicating/repeating some image frames with lower respective color tone delta (Δ) values of the set of image frames 706 multiple times, e.g., up to a configured limit of repetitions. In other aspects, such as for a scenario 714, the display processor may be configured to duplicate/repeat 40 image frames of the set of image frames 706 having the lowest respective color tone delta (Δ) values of the set of image frames 706 (e.g., 50+40=90, where frame 3, frame 5, . . . , are not duplicated). In aspects for which 100 frames are generated, and referring back to the scenario 712, having increased the number of frames to 100, 10 frames will then be dropped (e.g., 100−90=10). For example, rather than dropping every tenth image frame present after the duplication/repetition of the set of image frames 706 as with the patterned algorithm or mathematical model described with respect to FIG. 4, the display processor may be configured to determine which image frames of the set of image frames 706 are to be dropped to achieve 90 FPS (Y) for the display panel 704 based on a spread of color tones, as described for aspects herein with reference to the diagram 500 in FIG. 5 and the diagram 600 in FIG. 6 (e.g., with consideration for content/characteristics of pixels in a given frame). As shown, a second instance of frame 1, a second instance of frame 3, a second instance of frame 4, . . . , will be dropped based on the color tone spread and respective color tone delta (Δ) values for the image frames to rate match at 90 FPS (Y).

Accordingly, aspects provide for a user experience that is smoother as the transition between frames is more gradual, even when frames are dropped to rate match the FPS of the display panel 704.

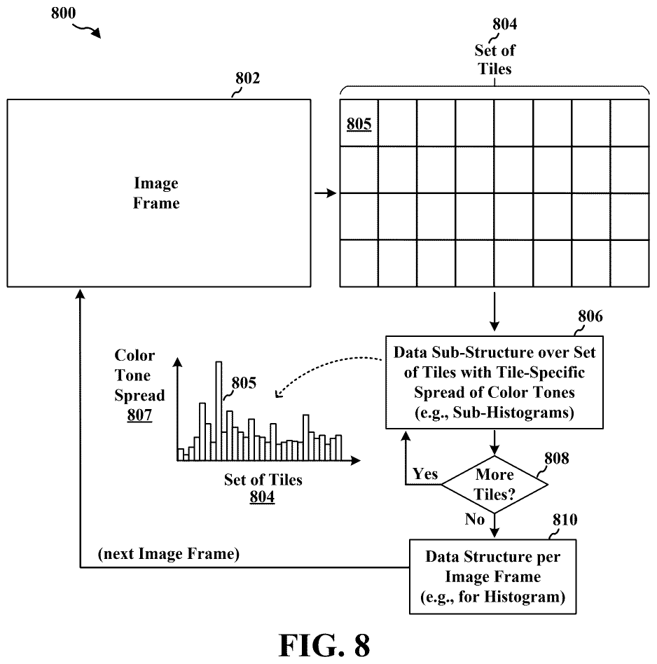

FIG. 8 is a diagram 800 illustrating example tile-based histograms for frame dropping for smooth motion in accordance with one or more techniques of this disclosure. Diagram 800 may be an aspect of diagram 500 in FIG. 5 for the generation of a histogram, as described herein. In aspects, operations of diagram 800 may be performed by a display processor/DPU or the like, e.g., the display processor 127/the histogram-based frame processor 198 in FIG. 1.

Aspects herein also provide for local histograms to be employed from a display processor's destination surface processor pipe (DSPP) block for increased accuracy and/or granularity. Diagram 800 shows an example image frame 802 in the context of a set of tiles 804 which comprise the image frame 802. For example, in aspects, to generate a data structure (e.g., a histogram) indicative of a spread of color tones 807 between a set of image frames associated with a first frame rate of a source application, the display processor may be configured to divide the image frame 802 of the first subset of image frames into the set of tiles 804 that comprise the image frame 802. The display processor may be configured to utilize a local histogram algorithm to divide the large frame into a smaller, equal number of local tiles (e.g., the set of tiles 804 comprising instances of the tile 805) and generate a sub-histogram for each tile. For example, the display processor may be configured to generate a data sub-structure 806 associated with each tile 805 of the set of tiles 804, where each instance of the data sub-structure 806 is indicative of a tile-specific spread of color tones 807 for the image frame 802. That is, each tile 805 of the set of tiles 804 may be iterated over (e.g., at 808) until each tile 805 is processed for the data sub-structure 806. In aspects, the display processor may be configured to generate the data structure 810 per image frame (e.g., for frames of the histogram 502 in FIG. 5) over a set of image frames, as described herein.

Aspects enable the use of local histograms to provide an even more efficient analysis, at improved granularities, of color tones of each frame which can be used for the described histograms herein. Based on completed histogram data, the aspects herein provide for the use of color tone spread 807 and color tone delta(s) (Δ) to rank and determine which frames can be dropped accordingly, with increased efficiency/ granularity, via tile-specific spread of color tones of each data sub-structure 806 (e.g., each individual, sub-histogram) associated with each tile 805 of the set of tiles 804.

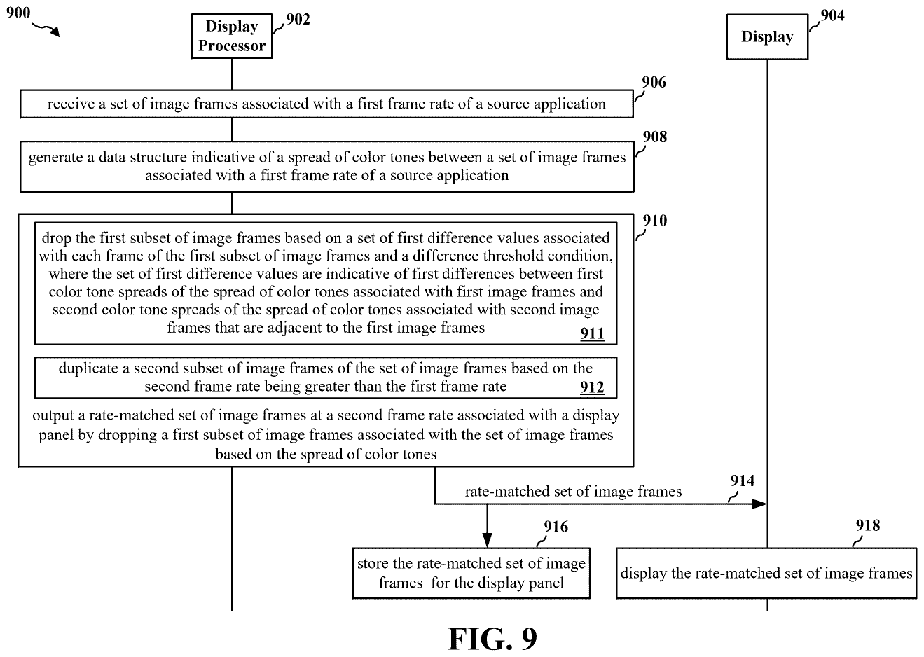

FIG. 9 is a call flow diagram 900 illustrating example communications between a display processor 902 and a display panel 904 based on/associated with one or more techniques of this disclosure. In aspects, call flow diagram 900 is described for histogram-based frame dropping for smooth motion. In an example, the display processor 902 may be or include the display processor 127/the histogram-based frame processor 198. In an example, the display panel 904 may be or include the display(s) 131.

At 906, the display processor 902 may be configured to receive a set of image frames associated with a first frame rate of a source application. In one example, the set of image frames includes a second number of image frames corresponding to a first number of image frames per second of the first frame rate of the source application. In one example, the set of image frames may be received from the source application, such a game, a video application, a content streaming application, an extended reality (XR) application, and/or the like.

At 908, the display processor 902 may be configured to generate a data structure indicative of a spread of color tones between a set of image frames associated with a first frame rate of a source application. In one example, to generate a data structure indicative of a spread of color tones between a set of image frames, the display processor 902 may be configured to determine a respective color tone spread for each image frame in the set of image frames. In one example, to generate a data structure indicative of a spread of color tones between a set of image frames, the display processor 902 may be configured to associate each image frame in the set of image frames with (i) the respective color tone spread and with (ii) a set of adjacent image frames that are prior to or subsequent to each image frame.

At 910, the display processor 902 may be configured to output a rate-matched set of image frames 914 at a second frame rate associated with a display panel by dropping a first subset of image frames associated with the set of image frames based on the spread of color tones. In one example, the rate-matched set of image frames includes a first number of image frames corresponding to a second number of image frames per second of the second frame rate of the display panel 904.

In one example, to output (at 910) the rate-matched set of image frames 916, the display processor 902 may be configured to drop (at 911) the first subset of image frames based on a set of first difference values (e.g., delta(s) (Δ)) associated with each frame of the first subset of image frames and a difference threshold condition, where the set of first difference values (e.g., delta(s) (Δ)) are indicative of first differences between first color tone spreads of the spread of color tones associated with first image frames and second color tone spreads of the spread of color tones associated with second image frames that are adjacent to the first image frames. In one example, the set of first difference values (e.g., delta(s) (Δ)) may be less than or equal to the difference threshold condition. In one example, the first differences may comprise a set of smallest differences of the set of first difference values (e.g., delta(s) (Δ)). In one example, the difference threshold condition may be associated with a percentage difference, an absolute difference, or a distributional difference of color tone spreads. In one example, the first subset of image frames may comprise two or more consecutive image frames of the set of image frames.

In one example, to output (at 910) the rate-matched set of image frames 914, the display processor 902 may be configured to duplicate (at 912) a second subset of image frames of the set of image frames based on the second frame rate being greater than the first frame rate. In one example, to duplicate the second subset of image frames, the display processor 902 may be configured to duplicate the second subset of image frames based on the spread of color tones. In one example, to duplicate the second subset of image frames, the display processor 902 may be configured to duplicate the second subset of image frames based on a set of second difference values (e.g., delta(s) (Δ)) associated with each frame in the second subset of image frames and the difference threshold condition, where the set of second difference values (e.g., delta(s) (Δ)) are indicative of second differences between third color tone spreads of the spread of color tones associated with third image frames and fourth color tone spreads of the spread of color tones associated with fourth image frames that are adjacent to the third image frames. In one example, the set of second difference values (e.g., delta(s) (Δ)) may be greater than or equal to the difference threshold condition. In one example, the second differences may comprise a set of largest differences of the set of second difference values (e.g., delta(s) (Δ)). In one example, to duplicate the second subset of image frames, the display processor 902 may be configured to duplicate the second subset of image frames prior to dropping the first subset of image frames. In one example, to duplicate the second subset of image frames, the display processor 902 may be configured to duplicate image frames of the second subset of image frames for a respective placement adjacent to a corresponding duplicated image frame.

In one example, to output (at 910) a rate-matched set of image frames 914, the display processor 902 may be configured to store (at 916), in a memory, the rate-matched set of image frames 914 at the second frame rate associated with the display panel 904. In one example, to output a rate-matched set of image frames, the display processor 902 may be configured to provide, for the display panel 904, the rate-matched set of image frames 914 at the second frame rate associated with the display panel 904.

At 918, the display panel 904 may be configured to display the rate-matched set of image frames 914 (e.g., received from the display processor 902). In some aspects, the display panel 904 may be configured to display the rate-matched set of image frames 914 at the device 104.

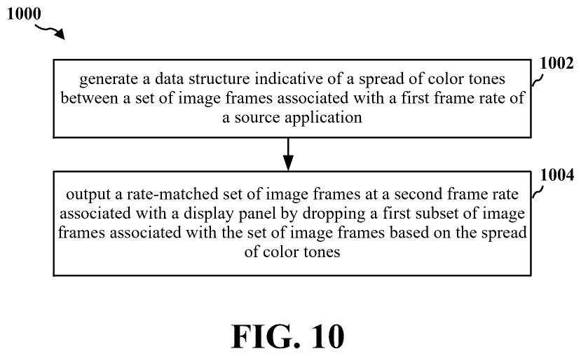

FIG. 10 is a flowchart 1000 of an example method of display processing in accordance with one or more techniques of this disclosure. The method may be performed by an apparatus, such as an apparatus for display processing, a display processing unit (DPU) or other display processor (e.g., the display processor 127), a wireless communication device, and the like, as used in connection with the aspects of FIGS. 1-8. In an example, the method may be associated histogram-based frame dropping for smooth motion at a device (e.g., the device 104). In an example, the method may be performed by the histogram-based frame processor 198.

At 1002, the apparatus (e.g., a display processor) generates a data structure indicative of a spread of color tones between a set of image frames associated with a first frame rate of a source application. For example, referring to FIG. 9, the display processor 902 may be configured to receive (at 906) a set of image frames (e.g., 504 in FIG. 5; 602 in FIG. 6; 706 in FIG. 7; 802 in FIG. 8) associated with a first frame rate of a source application (e.g., 702 in FIG. 7), and the display processor 902 may be configured to generate (at 908) a data structure (e.g., 502 in FIG. 5; 810 in FIG. 8) indicative of a spread of color tones (e.g., 502 in FIG. 5; 807 in FIG. 8) between a set of image frames (e.g., 504 in FIG. 5; 602 in FIG. 6; 706 in FIG. 7; 802 in FIG. 8) associated with a first frame rate (e.g., X fps in FIGS. 6, 7) of a source application (e.g., 702 in FIG. 7). In one example, to generate (at 908) a data structure (e.g., 506 in FIG. 5; 810 in FIG. 8) indicative of a spread of color tones (e.g., 502 in FIG. 5; 807 in FIG. 8) between a set of image frames (e.g., 504 in FIG. 5; 602 in FIG. 6; 706 in FIG. 7; 802 in FIG. 8), the display processor 902 may be configured to determine (e.g., at 605 in FIG. 6) a respective color tone spread (e.g., 502 in FIG. 5; 807 in FIG. 8) for each image frame (e.g., N, 504i in FIG. 5; 802 in FIG. 8) in the set of image frames (e.g., 504 in FIG. 5; 602 in FIG. 6; 706 in FIG. 7; 802 in FIG. 8). In one example, to generate a data structure (e.g., 502 in FIG. 5; 810 in FIG. 8) indicative of a spread of color tones (e.g., 502 in FIG. 5; 807 in FIG. 8) between a set of image frames (e.g., 504 in FIG. 5; 602 in FIG. 6; 706 in FIG. 7; 802 in FIG. 8), the display processor 902 may be configured to associate each image frame (e.g., N, 504i in FIG. 5; 802 in FIG. 8) in the set of image frames (e.g., 504 in FIG. 5; 602 in FIG. 6; 706 in FIG. 7; 802 in FIG. 8) with (i) the respective color tone spread (e.g., 502 in FIG. 5; 807 in FIG. 8) and with (ii) a set of adjacent image frames (e.g., N−1 in FIG. 5) that are prior to or subsequent to each image frame (e.g., N, 504i in FIG. 5; 802 in FIG. 8).

At 1004, the apparatus (e.g., a display processor) outputs a rate-matched set of image frames at a second frame rate associated with a display panel by dropping a first subset of image frames associated with the set of image frames based on the spread of color tones. For example, referring to FIG. 9 (at 910), the display processor 902 may be configured to output (e.g., at 612 in FIG. 6) a rate-matched set of image frames 914 (e.g., in 708, 710, 712, 714 in FIG. 7) at a second frame rate (e.g., Y fps in FIGS. 6, 7) associated with a display panel (e.g., 704 in FIG. 7) by dropping (e.g., at 611 in FIG. 6; 708, 712 in FIG. 7) a first subset of image frames (e.g., 622 in FIG. 6) associated with the set of image frames (e.g., 504 in FIG. 5; 602 in FIG. 6; 706 in FIG. 7; 802 in FIG. 8) based on the spread of color tones (e.g., 502 in FIG. 5; 807 in FIG. 8). In one example, the rate-matched set of image frames 914 (e.g., in 708, 710, 712, 714 in FIG. 7) includes a first number of image frames corresponding to a second number of image frames per second of the second frame rate (e.g., Y fps in FIGS. 6, 7) of the display panel 904 (e.g., 704 in FIG. 7).

In one example, to output (at 910) (e.g., at 612 in FIG. 6) the rate-matched set of image frames 916 (e.g., in 708, 710, 712, 714 in FIG. 7), the display processor 902 may be configured to drop (at 911) (e.g., at 611 in FIG. 6; 708, 712 in FIG. 7) the first subset of image frames (e.g., 622 in FIG. 6) based on a set of first difference values (e.g., delta(s) (Δ)) (e.g., 508 in FIG. 5; 626 in FIG. 6) associated with each frame (e.g., N, 504i in FIG. 5; 802 in FIG. 8) of the first subset of image frames (e.g., 622 in FIG. 6) and a difference threshold condition (e.g., 510 in FIG. 5), where the set of first difference values (e.g., delta(s) (Δ)) (e.g., 508 in FIG. 5; 626 in FIG. 6) are indicative of first differences (e.g., delta(s) (Δ)) (e.g., 508 in FIG. 5; 626 in FIG. 6) between first color tone spreads of the spread of color tones (e.g., 502 in FIG. 5; 807 in FIG. 8) associated with first image frames and second color tone spreads of the spread of color tones (e.g., 502 in FIG. 5; 807 in FIG. 8) associated with second image frames that are adjacent to the first image frames. In one example, the set of first difference values (e.g., delta(s) (Δ)) (e.g., 508 in FIG. 5; 626 in FIG. 6) may be less than or equal to the difference threshold condition (e.g., 510 in FIG. 5). In one example, the first differences (e.g., delta(s) (Δ)) (e.g., 508 in FIG. 5; 626 in FIG. 6) may comprise a set of smallest differences (e.g., 622 in FIG. 6) of the set of first difference values. (e.g., delta(s) (Δ)) (e.g., 508 in FIG. 5; 626 in FIG. 6) In one example, the difference threshold condition (e.g., 510 in FIG. 5) may be associated with a percentage difference, an absolute difference, or a distributional difference of color tone spreads (e.g., 502 in FIG. 5; 807 in FIG. 8). In one example, the first subset of image frames (e.g., 622 in FIG. 6) may comprise two or more consecutive image frames of the set of image frames (e.g., 504 in FIG. 5; 602 in FIG. 6; 706 in FIG. 7; 802 in FIG. 8).

In one example, to output (at 910) (e.g., at 612 in FIG. 6) the rate-matched set of image frames 916, the display processor 902 may be configured to duplicate (at 912) (e.g., at 611 in FIG. 6; 710, 712, 714 in FIG. 7) a second subset of image frames (e.g., 624 in FIG. 6) of the set of image frames (e.g., 504 in FIG. 5; 602 in FIG. 6; 706 in FIG. 7; 802 in FIG. 8) based on the second frame rate (e.g., Y fps in FIGS. 6, 7) being greater than the first frame rate (e.g., X fps in FIGS. 6, 7). In one example, to duplicate (e.g., at 611 in FIG. 6; 710, 712, 714 in FIG. 7) the second subset of image frames (e.g., 624 in FIG. 6), the display processor 902 may be configured to duplicate (e.g., at 611 in FIG. 6; 710, 712, 714 in FIG. 7) the second subset of image frames (e.g., 624 in FIG. 6) based on the spread of color tones (e.g., 502 in FIG. 5; 807 in FIG. 8). In one example, to duplicate (e.g., at 611 in FIG. 6; 710, 712, 714 in FIG. 7) the second subset of image frames (e.g., 624 in FIG. 6), the display processor 902 may be configured to duplicate (e.g., at 611 in FIG. 6; 710, 712, 714 in FIG. 7) the second subset of image frames (e.g., 624 in FIG. 6) based on a set of second difference values (e.g., delta(s) (Δ)) (e.g., 508 in FIG. 5; 626 in FIG. 6) associated with each frame (e.g., N, 504i in FIG. 5; 802 in FIG. 8) in the second subset of image frames (e.g., 624 in FIG. 6) and the difference threshold condition (e.g., 510 in FIG. 5), where the set of second difference values (e.g., delta(s) (Δ)) (e.g., 508 in FIG. 5; 626 in FIG. 6) are indicative of second differences (e.g., delta(s) (Δ)) (e.g., 508 in FIG. 5; 626 in FIG. 6) between third color tone spreads of the spread of color tones (e.g., 502 in FIG. 5; 807 in FIG. 8) associated with third image frames and fourth color tone spreads of the spread of color tones (e.g., 502 in FIG. 5; 807 in FIG. 8) associated with fourth image frames that are adjacent to the third image frames. In one example, the set of second difference values (e.g., delta(s) (Δ)) (e.g., 508 in FIG. 5; 626 in FIG. 6) may be greater than or equal to the difference threshold condition (e.g., 510 in FIG. 5). In one example, the second differences may comprise a set of largest differences (e.g., 624 in FIG. 6) of the set of second difference values (e.g., delta(s) (Δ)) (e.g., 508 in FIG. 5; 626 in FIG. 6). In one example, to duplicate (e.g., at 611 in FIG. 6; 710, 712, 714 in FIG. 7) the second subset of image frames (e.g., 624 in FIG. 6), the display processor 902 may be configured to duplicate (e.g., at 611 in FIG. 6; 710, 712, 714 in FIG. 7) the second subset of image frames (e.g., 624 in FIG. 6) prior to dropping (e.g., at 611 in FIG. 6; 708, 712 in FIG. 7) the first subset of image frames (e.g., 622 in FIG. 6). In one example, to duplicate (e.g., at 611 in FIG. 6; 710, 712, 714 in FIG. 7) the second subset of image frames (e.g., 624 in FIG. 6), the display processor 902 may be configured to duplicate (e.g., at 611 in FIG. 6; 710, 712, 714 in FIG. 7) image frames of the second subset of image frames (e.g., 624 in FIG. 6) for a respective placement adjacent to a corresponding duplicated image frame.

In one example, to output (at 910) (e.g., at 612 in FIG. 6) a rate-matched set of image frames 914 (e.g., in 708, 710, 712, 714 in FIG. 7), the display processor 902 may be configured to store (at 916), in a memory, the rate-matched set of image frames 914 (e.g., in 708, 710, 712, 714 in FIG. 7) at the second frame rate (e.g., Y fps in FIGS. 6, 7) associated with the display panel 904 (e.g., 704 in FIG. 7). In one example, to output (e.g., at 612 in FIG. 6) a rate-matched set of image frames 914 (e.g., in 708, 710, 712, 714 in FIG. 7), the display processor 902 may be configured to provide, for the display panel 904 (e.g., 704 in FIG. 7), the rate-matched set of image frames 914 (e.g., in 708, 710, 712, 714 in FIG. 7) at the second frame rate (e.g., Y fps in FIGS. 6, 7) associated with the display panel 904 (e.g., 704 in FIG. 7).

In examples, 1002 and/or 1004 may be performed by the histogram-based frame processor 198.

In configurations, a method or an apparatus for graphics processing is provided. The apparatus may be a display processor, a DPU, a CPU (or other central processor), a display driver integrated circuit (DDIC), an apparatus for display processing, and/or some other processor that may perform display processing. In aspects, the apparatus may be the display processor 127 within the device 104, or may be some other hardware within the device 104 or another device. The apparatus, e.g., display processor 127, may include means for generating a data structure indicative of a spread of color tones between a set of image frames associated with a first frame rate of a source application. The apparatus, e.g., display processor 127, may include means for outputting a rate-matched set of image frames at a second frame rate associated with a display panel by dropping a first subset of image frames associated with the set of image frames based on the spread of color tones. The apparatus, e.g., display processor 127, may further include means for dropping the first subset of image frames based on a set of first difference values associated with each frame of the first subset of image frames and a difference threshold condition, where the set of first difference values are indicative of first differences between first color tone spreads of the spread of color tones associated with first image frames and second color tone spreads of the spread of color tones associated with second image frames that are adjacent to the first image frames. The apparatus, e.g., display processor 127, may further include means for duplicating a second subset of image frames of the set of image frames based on the second frame rate being greater than the first frame rate. The apparatus, e.g., display processor 127, may further include means for duplicating the second subset of image frames based on a set of second difference values associated with each frame in the second subset of image frames and the difference threshold condition, where the set of second difference values are indicative of second differences between third color tone spreads of the spread of color tones associated with third image frames and fourth color tone spreads of the spread of color tones associated with fourth image frames that are adjacent to the third image frames.

The subject matter described herein may be implemented to realize one or more benefits or advantages. For instance, the described display processing techniques may be used by a display processor, a DPU, a CPU, a central processor, or some other processor that may perform display processing to implement the histogram-based frame dropping for smooth motion described herein. This may also be accomplished at a greater efficiency, with improved granularity, compared to other display processing techniques. Moreover, the display processing techniques herein may improve the smoothness of display outputs when rate-matching between an application source and display panel is utilized.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, comprising: generating a data structure indicative of a spread of color tones between a set of image frames associated with a first frame rate of a source application; and outputting a rate-matched set of image frames at a second frame rate associated with a display panel by dropping a first subset of image frames associated with the set of image frames based on the spread of color tones.

Aspect 2 is the method of aspect 1, wherein dropping the first subset of image frames based on the spread of color tones includes: dropping the first subset of image frames based on a set of first difference values associated with each frame of the first subset of image frames and a difference threshold condition, wherein the set of first difference values are indicative of first differences between first color tone spreads of the spread of color tones associated with first image frames and second color tone spreads of the spread of color tones associated with second image frames that are adjacent to the first image frames.

Aspect 3 is the method of aspect 2, wherein the set of first difference values is less than or equal to the difference threshold condition.

Aspect 4 is the method of any of aspects 2 and 3, wherein the first differences comprise a set of smallest differences of the set of first difference values.

Aspect 5 is the method of any of aspects 2 to 4, wherein the difference threshold condition is associated with a percentage difference, an absolute difference, or a distributional difference of color tone spreads.

Aspect 6 is the method of aspect 2, wherein outputting the rate-matched set of image frames at the second frame rate includes: duplicating a second subset of image frames of the set of image frames based on the second frame rate being greater than the first frame rate.

Aspect 7 is the method of aspect 6, wherein duplicating the second subset of image frames includes duplicating the second subset of image frames based on the spread of color tones.

Aspect 8 is the method of aspect 7, wherein duplicating the second subset of image frames includes: duplicating the second subset of image frames based on a set of second difference values associated with each frame in the second subset of image frames and the difference threshold condition, wherein the set of second difference values are indicative of second differences between third color tone spreads of the spread of color tones associated with third image frames and fourth color tone spreads of the spread of color tones associated with fourth image frames that are adjacent to the third image frames.

Aspect 9 is the method of aspect 8, wherein the set of second difference values is greater than or equal to the difference threshold condition.

Aspect 10 is the method of any of aspects 8 and 9, wherein the second differences comprise a set of largest differences of the set of second difference values.

Aspect 11 is the method of any of aspects 7 to 10, wherein duplicating the second subset of image frames includes duplicating the second subset of image frames prior to dropping the first subset of image frames.

Aspect 12 is the method of any of aspects 7 to 11, wherein duplicating the second subset of image frames includes duplicating images frames of the second subset of image frames for a respective placement adjacent to a corresponding duplicated image frame.

Aspect 13 is the method of any of aspects 1 to 12, wherein the first subset of image frames comprises two or more consecutive image frames of the set of image frames.

Aspect 14 is the method of any of aspects 1 to 13, wherein generating the data structure indicative of the spread of color tones includes: determining a respective color tone spread for each image frame in the set of image frames; and associating each image frame in the set of image frames with (i) the respective color tone spread and with (ii) a set of adjacent image frames that are prior to or subsequent to each image frame.

Aspect 15 is the method of any of aspects 1 to 14, wherein the set of image frames includes a second number of image frames corresponding to a first number of image frames per second of the first frame rate of the source application.

Aspect 16 is the method of any of aspects 1 to 15, wherein the rate-matched set of image frames includes a first number of image frames corresponding to a second number of image frames per second of the second frame rate of the display panel.

Aspect 17 is the method of any of aspects 1 to 16, wherein generating the data structure indicative of the spread of color tones includes: dividing an image frame of the first subset of image frames into a set of tiles that comprise the image frame; and generating a data sub-structure associated with each tile of the set of tiles, wherein each data sub-structure is indicative of a tile-specific spread of color tones; wherein the spread of color tones is based on the tile-specific spread of color tones of each data sub-structure.

Aspect 18 is the method of any of aspects 1 to 17, wherein outputting the rate-matched set of image frames at the second frame rate associated with the display panel includes at least one of: providing, for the display panel, the rate-matched set of image frames at the second frame rate associated with the display panel; or storing, in a memory, the rate-matched set of image frames at the second frame rate associated with the display panel.

Aspect 19 is an apparatus for display processing comprising a processor coupled to a memory and, based on information stored in the memory, the processor is configured to implement a method as in any of aspects 1-18.

Aspect 20 may be combined with aspect 19 and comprises that the apparatus is a wireless communication device.

Aspect 21 is an apparatus for display processing comprising means for implementing a method as in any of aspects 1-18.

Aspect 22 is a computer-readable medium (e.g., a non-transitory computer readable-medium) storing computer executable code, the computer executable code, when executed by a processor, causes the processor to implement a method as in any of aspects 1-18.

Various aspects have been described herein. These and other aspects are within the scope of the following claims.

What is claimed is:

1. An apparatus for display processing, comprising:
a memory; and
a processor coupled to the memory, wherein, based on information stored in the memory, the processor is configured to:
generate a data structure indicative of a spread of color tones between a set of image frames associated with a first frame rate of a source application; and
output a rate-matched set of image frames at a second frame rate associated with a display panel by dropping a first subset of image frames associated with the set of image frames based on the spread of color tones.

2. The apparatus of claim 1, wherein to drop the first subset of image frames based on the spread of color tones, the processor is configured to:
drop the first subset of image frames based on a set of first difference values associated with each frame of the first subset of image frames and a difference threshold condition, wherein the set of first difference values are indicative of first differences between first color tone spreads of the spread of color tones associated with first image frames and second color tone spreads of the spread of color tones associated with second image frames that are adjacent to the first image frames.

3. The apparatus of claim 2, wherein the set of first difference values is less than or equal to the difference threshold condition.

4. The apparatus of claim 2, wherein the first differences comprise a set of smallest differences of the set of first difference values.

5. The apparatus of claim 2, wherein the difference threshold condition is associated with a percentage difference, an absolute difference, or a distributional difference of color tone spreads.

6. The apparatus of claim 2, wherein to output the rate-matched set of image frames at the second frame rate, the processor is configured to:
duplicate a second subset of image frames of the set of image frames based on the second frame rate being greater than the first frame rate.

7. The apparatus of claim 6, wherein to duplicate the second subset of image frames, the processor is configured to duplicate the second subset of image frames based on the spread of color tones.

8. The apparatus of claim 7, wherein to duplicate the second subset of image frames, the processor is configured to:
duplicate the second subset of image frames based on a set of second difference values associated with each frame in the second subset of image frames and the difference threshold condition, wherein the set of second difference values are indicative of second differences between third color tone spreads of the spread of color tones associated with third image frames and fourth color tone spreads of the spread of color tones associated with fourth image frames that are adjacent to the third image frames.

9. The apparatus of claim 8, wherein the set of second difference values is greater than or equal to the difference threshold condition.

10. The apparatus of claim 8, wherein the second differences comprise a set of largest differences of the set of second difference values.

11. The apparatus of claim 7, wherein to duplicate the second subset of image frames, the processor is configured to duplicate the second subset of image frames prior to dropping the first subset of image frames.

12. The apparatus of claim 7, wherein to duplicate the second subset of image frames, the processor is configured to duplicate image frames of the second subset of image frames for a respective placement adjacent to a corresponding duplicated image frame.

13. The apparatus of claim 1, wherein the first subset of image frames comprises two or more consecutive image frames of the set of image frames.

14. The apparatus of claim 1, wherein to generate the data structure indicative of the spread of color tones, the processor is configured to:
determine a respective color tone spread for each image frame in the set of image frames; and
associate each image frame in the set of image frames with (i) the respective color tone spread and with (ii) a set of adjacent image frames that are prior to or subsequent to each image frame.

15. The apparatus of claim 1, wherein the set of image frames includes a second number of image frames corresponding to a first number of image frames per second of the first frame rate of the source application.

16. The apparatus of claim 1, wherein the rate-matched set of image frames includes a first number of image frames corresponding to a second number of image frames per second of the second frame rate of the display panel.

17. The apparatus of claim 1, wherein to generate the data structure indicative of the spread of color tones, the processor is configured to:
divide an image frame of the first subset of image frames into a set of tiles that comprise the image frame; and
generate a data sub-structure associated with each tile of the set of tiles,
wherein each data sub-structure is indicative of a tile-specific spread of color tones;
wherein the spread of color tones is based on the tile-specific spread of color tones of each data sub-structure.

18. The apparatus of claim 1, wherein to output the rate-matched set of image frames at the second frame rate associated with the display panel, the processor is configured to at least one of:
provide, for the display panel, the rate-matched set of image frames at the second frame rate associated with the display panel, wherein the apparatus is a wireless communication device; or
store, in the memory, the rate-matched set of image frames at the second frame rate associated with the display panel.

19. A method of display processing, comprising:
generating a data structure indicative of a spread of color tones between a set of image frames associated with a first frame rate of a source application; and
outputting a rate-matched set of image frames at a second frame rate associated with a display panel by dropping a first subset of image frames associated with the set of image frames based on the spread of color tones.

20. A computer-readable medium storing computer executable code at a device, the code when executed by a processor causes the processor to:
generate a data structure indicative of a spread of color tones between a set of image frames associated with a first frame rate of a source application; and
output a rate-matched set of image frames at a second frame rate associated with a display panel by dropping a first subset of image frames associated with the set of image frames based on the spread of color tones.
